(19) United States
(12) Patent Application Publication
(10) Pub. No.: US 2003/0232129 A1
(43) Pub. Date: Dec. 18, 2003

(54) Method of manufacturing a color filter cathode ray tube (CRT)

(76) Inventor: Farzad Parsapour, Reading, PA (US)

Correspondence Address: Joseph S. Tripoli, THOMSON multimedia Licensing Inc., Two Independence Way, Patent Operations, Post Office Box 5312, Princeton, NJ, 08540-5312, US

(21) Appl. No.: 10/170,116

(22) Filed: Jun. 12, 2002

(51) Int. Cl. B05D 5/12

(52) U.S. Cl. 427/68

(57) ABSTRACT

A method of manufacturing a luminescent screen assembly for a cathode ray tube (CRT) is disclosed. The luminescent screen assembly is formed on an interior surface of a faceplate panel of the CRT. The luminescent screen assembly includes a patterned light absorbing matrix that defines a first set of fields, a second set of fields, and a third set of fields. A blocking layer is formed over the second set of fields and the third set of fields. A pigment layer is then applied to the first set of fields. The blocking layer is removed from the second set of fields and the third set of fields to form a color filter in the first set of fields. Another pigment may be applied to the second set of fields to form a color filter therein.

### BACKGROUND OF THE INVENTION

The invention relates to a color cathode ray tube (CRT) and, more particularly to the manufacturing of a luminescent screen assembly having at least one color filter.

### DESCRIPTION OF THE BACKGROUND ART

A color cathode ray tube (CRT) typically includes an electron gun an aperture mask, and a screen. The aperture mask is interposed between the electron gun and the screen. The screen is located on an inner surface of a faceplate of the CRT tube. The aperture mask functions to direct electron beams generated in the electron gun toward appropriate color-emitting phosphors on the screen of the CRT tube.

The screen may be a luminescent screen. Luminescent screens typically comprise an array of three different color-emitting phosphors (e.g., green, blue and red) formed thereon. Each of the color emitting phosphors is separated from another by a matrix line. The matrix lines are typically formed of a light absorbing black, inert material.

In order to enhance the color contrast of the luminescent screen, a pigment layer, or color filter, may be formed between the faceplate panel and the color-emitting phosphor. The color filter typically has a color that corresponds to the color of the color-emitting phosphor formed thereon (e.g., a red-emitting phosphor is formed on a red pigmented filter). The color filter transmits light that is within the emission spectral region of the phosphor formed thereon and absorbs ambient light in other spectral regions, providing a gain in color contrast.

The color filters are typically formed using a subtractive process in which the color filter layer is deposited on the luminescent screen, and, in a subsequent development process, select portions of the filter layer are removed, such that a color filter is formed only on select portions of the faceplate panel. Unfortunately, color filters formed using such a process may adhere to the faceplate panel with sufficient tenacity on portions not intended to be covered therewith causing the faceplate panel to become contaminated. Color filter contamination reduces the contrast of the luminescent screen.

Thus, a need exists for a method of forming a color filter cathode ray tube (CRT) that overcomes the above drawbacks.

### SUMMARY OF THE INVENTION

The present invention relates to a method of manufacturing a color filter luminescent screen assembly for a cathode ray tube (CRT). The luminescent screen assembly is formed on an interior surface of a faceplate panel of the CRT tube. The luminescent screen assembly includes a patterned light-absorbing matrix that defines a first set of fields, a second set of fields, and a third set of fields corresponding to one of a blue region, a green region and a red region.

A blocking layer is applied over the second set of fields and the third set of fields. The blocking layer may comprise a photosensitive material and optionally one or more filler materials. The one or more filler materials may function to increase the porosity of the blocking layer. A pigment layer is then applied to the first set of fields to form a color filter. The pigment layer may be, for example, either a red pigment layer or a blue pigment layer. After the color filter is formed, the blocking layer is removed from the second set of fields and the third set of fields.

### BRIEF DESCRIPTION OF THE DRAWINGS

The invention will now be described in greater detail, with relation to the accompanying drawings, in which:

FIG. 1 is a plan view, partly in axial section, of a color cathode ray tube (CRT) made according to embodiments of the present invention;

FIG. 2 is a section of the faceplate panel of the CRT of FIG. 1, showing a luminescent screen assembly;

FIG. 3 is a block diagram comprising a flow chart of the manufacturing process of the screen assembly of FIG. 2;

FIG. 4 depicts views of the interior surface of the faceplate panel of a luminescent screen assembly during formation of one color filter;

FIG. 5 depicts views of the interior surface of the faceplate panel of a luminescent screen assembly during formation of a second color filter.

### DETAILED DESCRIPTION OF THE INVENTION

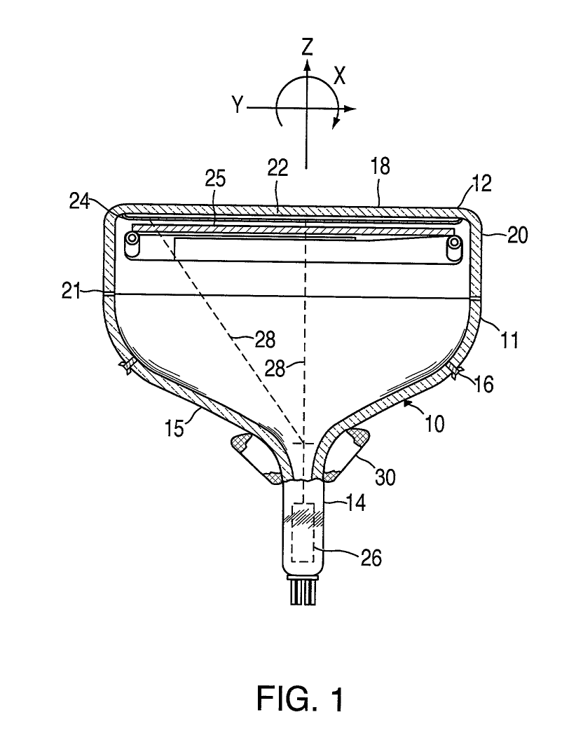

FIG. 1 shows a conventional color cathode ray tube (CRT) 10 having a glass envelope 11 comprising a faceplate panel 12 and a tubular neck 14 connected by a funnel 15. The funnel 15 has an internal conductive coating (not shown) that is in contact with, and extends from, an anode button 16 to the neck 14.

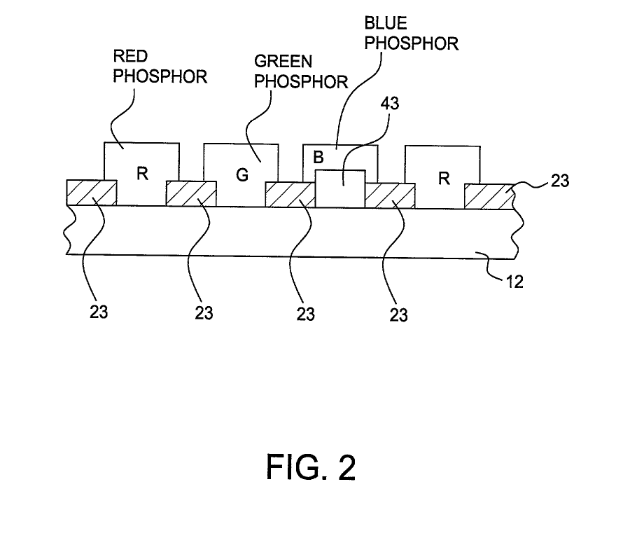

The faceplate panel 12 comprises a viewing surface 18 and a peripheral flange or sidewall 20 that is sealed to the funnel 15 by a glass frit 21. A three-color luminescent phosphor screen 22 is carried on the inner surface of the faceplate panel 12. The screen 22, shown in cross-section in FIG. 2, is a line screen which includes a multiplicity of screen elements comprised of red-emitting, green-emitting, and blue-emitting phosphor stripes R, G, and B, respectively, arranged in triads, each triad including a phosphor line of each of the three colors. The R, G, B, phosphor stripes extend in a direction that is generally normal to the plane in which the electron beams are generated. At least one of the R and B phosphor stripes are formed on color filters 43. The color filters 43 each comprise a pigment that corresponds to the color of the phosphor stripe formed thereon.

A light-absorbing matrix 23, shown in FIG. 2, separates each of the phosphor lines. A thin conductive layer 24, preferably of aluminum, overlies the screen 22 and provides means for applying a uniform first anode potential to the screen 22, as well as for reflecting light, emitted from the phosphor elements, through the viewing surface 18. The screen 22 and the overlying aluminum layer 24 comprise a screen assembly.

A multi-aperture color selection electrode, or shadow mask 25 (shown in FIG. 1) is removably mounted, by conventional means, within the faceplate panel 12, in a predetermined spaced relation to the screen 22.

An electron gun 26, shown schematically by the dashed lines in FIG. 1, is centrally mounted within the neck 14, to generate three inline electron beams 28, a center and two side or outer beams, along convergent paths through the shadow mask 25 to the screen 22. The inline direction of the beams 28 is approximately normal to the plane of the paper.

The CRT of FIG. 1 is designed to be used with an external magnetic deflection yoke, such as a yoke 30, shown in the neighborhood of the funnel-to-neck junction. When activated, the yoke 30 subjects the three beams 28 to magnetic fields that cause the beams to scan a horizontal and vertical rectangular raster across the screen 22.

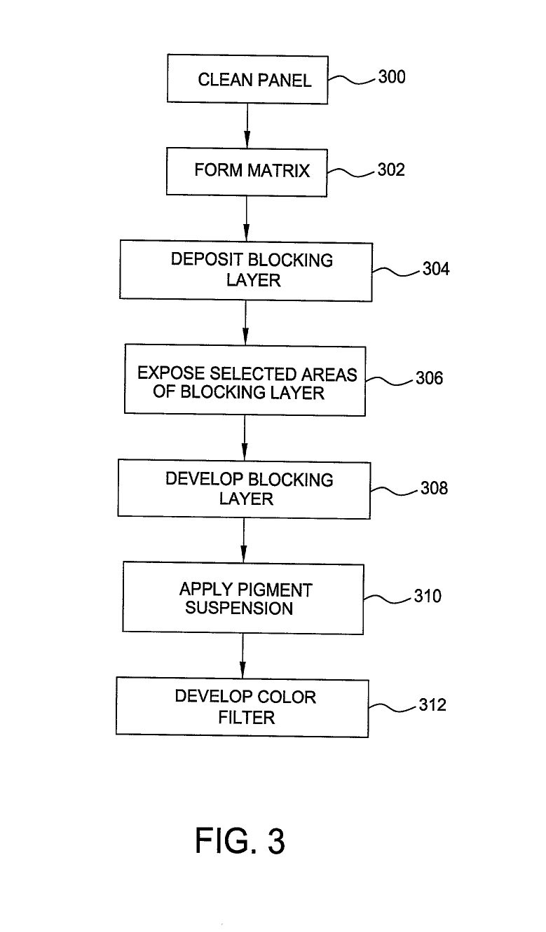

The screen 22 is manufactured according to the process steps represented schematically in FIG. 3. Initially, the faceplate panel 12 is cleaned, as indicated by reference numeral 300, by washing it with a caustic solution, rinsing it in water, etching it with buffered hydrofluoric acid and rinsing it again with water, as is known in the art.

The interior surface of the faceplate panel 12 is then provided with the light-absorbing matrix 23, as indicated by reference numeral 302, preferably using a wet matrix process in a manner described in U.S. Pat. Nos. 3,558,310, issued Jan. 26, 1971 to Mayaud, 6,013,400 issued Jan. 11, 2000 to LaPeruta et al., or 6,037,086 issued Mar. 14, 2000 to Gorog et al.

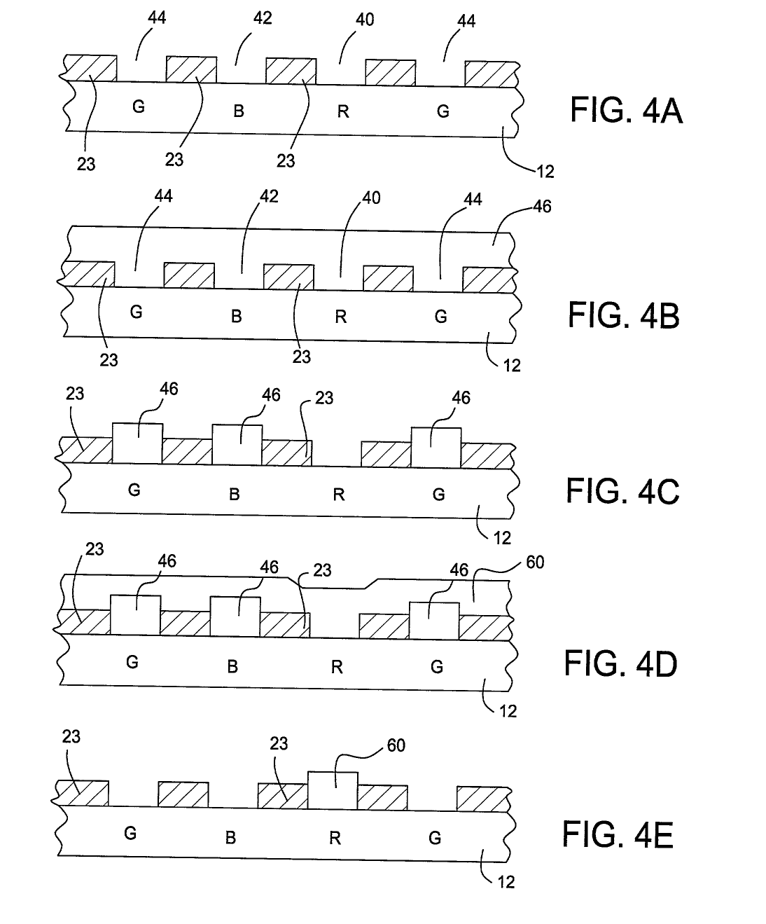

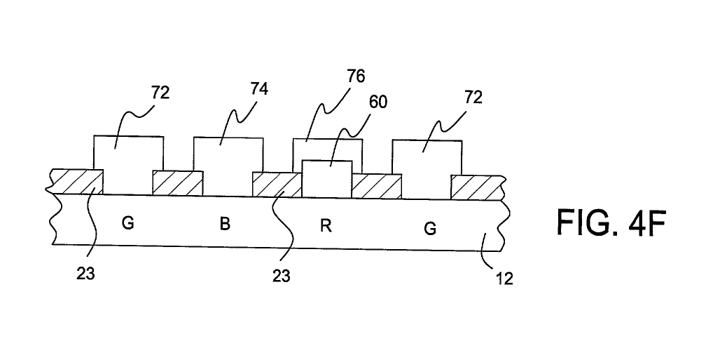

The light-absorbing matrix 23 is uniformly provided over the interior viewing surface of faceplate panel 12. For a faceplate panel 12 having a diagonal dimension of about 68 cm (27 inches), the openings 21 formed in the layer of light absorbing matrix 23 can have a width in a range of about 0.075 mm to about 0.25 mm, and the opaque matrix lines can have a width in a range of about 0.075 mm to about 0.30 mm. Referring to FIG. 4A, the light-absorbing matrix 23 defines three sets of fields; a first set of fields 40, a second set of fields 43, and a third set of fields 44.

As indicated by reference numeral 304 in FIG. 3, as well as FIG. 4B, a blocking layer 46 is deposited on the interior surface of the faceplate panel 12. The blocking layer 46 may include a photosensitive material. The photosensitive material may comprise, for example, an aqueous solution of sodium dichromate and a polymer such as polyvinyl alcohol. The blocking layer 46 may be formed on the faceplate panel 12 by spin coating the aqueous solution of the polymer and dichromate thereon.

In addition to the photosensitive material, the blocking layer 46 may also comprise a filler material that may function to increase the porosity thereof. The filler material may comprise for example, a powder having a particle size less than about 10 microns and preferably within a range of about 7 microns to about 8 microns. Suitable filler material may include, for example, alumina or zinc sulfide.

Addition of the filler material to the blocking layer allows the subsequent development of the blocking layer 46 to be performed using milder conditions. The use of milder development conditions may reduce the risk for damaging portions of the light-absorbing matrix 23.

Referring to reference numeral 306 in FIG. 3, the blocking layer 46 is irradiated using, for example, ultraviolet radiation, through the shadow mask 25 to cross-link the photosensitive material in the second set of fields 42 and the third set of fields 44. Cross-linking the blocking layer 46 in the second set of fields 42 and the third set of fields 44 hardens the photosensitive material in such fields.

The irradiated blocking layer 46 is then developed, as indicated by reference numeral 308 in FIG. 3, as well as FIG. 4C. The blocking layer 46 may be developed using, for example, deionized water. After development, the blocking layer 46 is removed over the first set of fields 40, while remaining on the faceplate panel 12 over the second set of fields 42 and the third set of fields 44.

Referring to reference numeral 310 in FIG. 3 as well as FIG. 4D, a first pigment is applied to the first set of fields 40. The first pigment may be applied from a first aqueous pigment suspension that may comprise, for example, the first pigment and one or more surface-active agents.

The first pigment suspension may further comprise at least one non-pigmented oxide particles. The at least one non-pigmented oxide particles may comprise a material, such as, for example, silica, alumina, or combinations thereof. The at least one non-pigmented oxide particles should have a size less than that of the pigment. Preferably, the average size of the at least one non-pigmented oxide particles should be less than about 50 nanometers. The at least one non-pigmented oxide particle is believed to enhance the adhesion of the pigment to the faceplate panel. The at least one non-pigmented oxide particle may be present in a concentration of about 5% to about 10% by weight with respect to the concentration the first pigment.

The first pigment may be, for example, a red pigment. Suitable red pigments may include, for example, a daipyroxide red pigment TM-3875, commercially available from Daicolor-Pope, Inc. of Paterson, N.J. Another suitable red pigment may include, for example, R2899 red pigment, commercially available from Elementis Pigments Co. of Fairview Heights, Ill., among other red pigments. Alternatively, the first pigment may be a blue pigment, such as a daipyroxide blue pigment TM-3490E, commercially available from Daicolor-Pope, Inc. of Paterson, N.J. Another suitable blue pigment may include, for example, EX 1041 blue pigment, commercially available from Shepherd Color Co. of Cincinnati, Ohio, among other blue pigments.

The pigments may be milled using a ball milling process in which the pigment is dispersed along with one or more surfactants in an aqueous suspension. The red pigments may be ball milled using for example, 1/16″ zirconium oxide (ZrO₂) balls for at least about 18 hours to about 92 hours. The blue pigments may be ball milled using for example, 1/16″ zirconium oxide (ZrO₂) balls for at least about 61 hours to about 90 hours.

The one or more surface-active agents may include, for example organic and polymeric compounds that may optionally adopt an electric charge in aqueous solution. The surface-active agent may comprise, anionic, non-ionic, cationic, and/or amphoteric materials. The surface-active agent may be used for various functions such as improving the homogeneity of the pigment in the aqueous pigment suspension, improved colloidal stability and improved wetting of the faceplate panel, among other functions. Examples of suitable surface-active agents include, various polymeric dispersants such as, for example, DISPEX N-40V and A-40 polymeric dispersants (commercially available from Ciba Specialty Chemicals of High Point, N.C.) as well as block copolymer surface active agents such as Pluronic Series (ethoxypropoxy co-polymers) L-62, commercially available from BASF Corp. of Germany, DAXAD 15 or 19, commercially available from Hampshire Chemical Company of Nashua, N.H., and carboxymethyl cellulose (CMC), commercially available from Yixing Tongda Chemical Co. Of China.

The first aqueous pigment suspension may be applied to the faceplate panel by, for example, spin coating in order to form a first color filter layer 60 in the first set of fields 40 of the faceplate panel 12. After spin coating, the first color filter layer 60 may be heated to a temperature in a range from about 55° C. to about 90° C. to provide increased adhesion of the first color filter 60 to the first set of fields 40 of the faceplate panel 12.

Referring to reference numeral 312 as well as FIG. 4E, the first color filter layer 60 is developed by applying an oxidizer to the first blocking layer 46. Suitable oxidizers may include, for example, periodic acid and hydrogen peroxide, among others. Water may than be applied to the faceplate panel 12 in order to remove the blocking layer 46 as well as the first color filter layer 60 over the second set of fields 42 and the third set of fields 44, leaving the first color filter 60 remaining in the first set of fields 40.

In one embodiment, either of a red filter or a blue filter is formed using the process described above with reference numerals 302 through 312 in FIG. 3. Thereafter, referring to FIG. 4F, the faceplate panel 12 may be screened with pigmented green phosphors 72, non-pigmented blue phosphors 74 and non-pigmented red phosphors 76, preferably, using a screening process in a manner described in U.S. Pat. Nos. 5,370,952, issued Dec. 6, 1994 to Datta et al., 5,554,468, issued Sep. 10, 1996 to Datta et al., 5,807,435 issued Sep. 15, 1998 to Poliniak et al., or 5,474,866 issued Dec. 12, 1995 to Ritt et al.

Alternatively, after the first color filter 60 is formed in the first set of fields 40, a second color filter may be formed in the second set of fields 42. For example, after a red color filter is formed, a blue color filter may be formed on the faceplate panel 12. For such an embodiment, the second color filter (blue color filter) may be formed on the faceplate panel by repeating the process steps described above with respect to reference numerals 302 through 312 in FIG. 3.

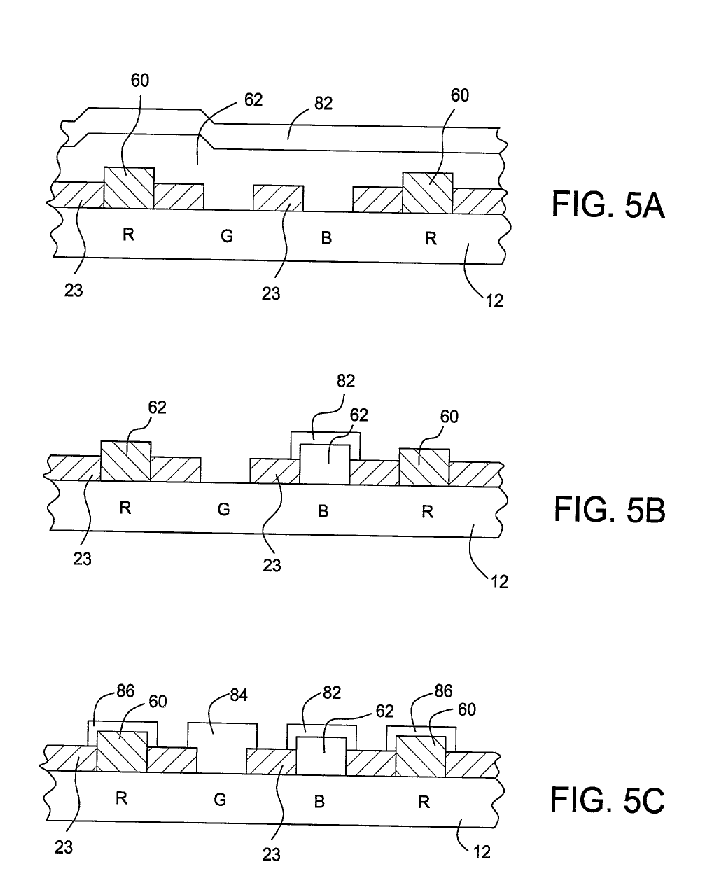

Referring to FIG. 5A, a second color filter, for example, a blue color filter may be formed by applying a second aqueous pigment suspension to the faceplate panel. The second aqueous pigment suspension may be applied to the faceplate panel by, for example, spin coating in order to form a second color filter layer 62 on the faceplate panel 12. The spin coated color filter layer may be heated to a temperature within a range of about 50° C. to about 65° C.

After the second color filter layer 62 is applied to the faceplate panel 12, a phosphor layer 82 may be formed thereon by, for example, spin coating. The spin coated phosphor layer 82 may be heated to a temperature within a range of about 50° C. to about 55° C.

The phosphor layer 82 is irradiated using, for example, ultraviolet radiation, through the shadow mask 25 to cross-link the phosphor layer 82 formed over the second color filter layer 62 in the second set of fields 42. Cross-linking the phosphor layer 82 over the second color filter layer 62 in the second set of fields 42 hardens the phosphor material in such regions.

The irradiated phosphor layer 82 is then developed as shown in FIG. 5B. The phosphor layer 82 may be developed using, for example, deionized water. After development, the phosphor layer 82 and the second color filter layer 62 are both removed in the first set of fields 40 over the first color filter 60 and in the third set of fields 44, while remaining on the faceplate panel 12 in the second set of fields 42.

Referring to FIG. 5C, the faceplate panel 12 may be screened with pigmented green phosphors 84 and non-pigmented red phosphors 86, preferably, using a screening process in a manner described in U.S. Pat. Nos. 5,370,952, issued Dec. 6, 1994 to Datta et al., 5,554,468, issued Sep. 10, 1996 to Datta et al., 5,807,435 issued Sep. 15, 1998 to Poliniak et al., or 5,474,866 issued Dec. 12, 1995 to Ritt et al.

In an exemplary luminescent screen assembly fabrication process, 20 inch faceplate panels having matrix lines formed thereon were soaked in warm water for 30 minutes, sprayed with water at 30 psi for 10 seconds and dried. The faceplate panels were then cooled to 27° C. A solution of 275 grams of water, 160 grams of 10% polyvinyl alcohol, and 21 grams of 10% sodium dichromate was prepared, and 120 milliliters of this solution was applied to the faceplate panels. The faceplate panels were spun at 190 rpm for 50 seconds, heated to 53° C. and cooled to 34° C. to form a photosensitive layer on each of the panels.

Each of the faceplate panels was irradiated using an ultraviolet source (0.4 milliwatts per square centimeter) for 40 seconds through a corresponding shadow mask, to cross-link the photosensitive material in the red fields and the green fields. The irradiated faceplate panels were developed using 43° C. water at 20 psi for 20 seconds and then dried. This resulted in the formation of a blocking layer in the red fields and the green fields, and the removal of the blocking layer in the blue fields.

A blue pigment concentrate was prepared by placing 190 grams of water, 7.5 grams of a polymeric dispersant, DISPEX N-40V (commercially available from Ciba Specialty Chemicals of High Point, N.C.) and 50 grams of TM-3480E Daipyroxide blue pigment (commercially available from Daicolor-Pope, Inc. of Paterson, N.J.) in a ball mill and milling the mixture using 1/16″ zirconium oxide balls for 62 hours. The average particle size of the pigment in the milled concentrate was 112 nanometers (nm) and the concentration of the red pigment in the milled concentrate was about 20 wt %.

Four batches of a blue pigment suspension, each having a different concentration of the blue pigment were prepared. Varying amounts of the pigment concentrate were mixed with 3.85-7.12 grams of a collodial silica, SNOWTEX XS (20% active silica, available from Nissan Chemical Industries of Tokyo, Japan), 2.5 grams of a 5% Pluronic Series (ethoxypropoxy co-polymer) L-62 solution (commercially available from BASF Corp. of Germany), and varying amounts of deionized water were mixed for 15 minutes to form the four blue pigment suspensions. The amount of deionized water added to each batch was sufficient to form individual blue pigment suspensions having concentrations of 10.0 weight % pigment, 12.5 weight % pigment, 14.0 weight % pigment and 18.7 weight % pigment.

Each blue pigment suspension was applied to one of the faceplate panels. The blue pigment suspension was applied to each faceplate panel at 28° C. and thereafter the panel was spun at 100 rpm for 20 seconds, heated to 65° C. and cooled to 34° C. to form a blue color filter layer on each faceplate panel.

Each of the blue color filter layers was developed by reheating the faceplate to 55° C. and applying 450 ml of 0.03-0.05% periodic acid solution to the faceplate. The periodic acid solution was swirled around the panel surface for 90 seconds. Thereafter, each faceplate panel was sprayed with 43° C. water at 40 psi for 15 seconds. This development step removed the blocking layer with the blue color filter layer thereon from both the red fields and the green fields, leaving a blue color filter in the blue fields.

Each of the faceplate panels with a blue color filter thereon was screened with standard green phosphors, non-pigmented blue phosphors and non-pigmented red phosphors.

Brightness contrast performance was measured for each of the four panels prepared above and compared to a luminescent screen assembly formed using a conventional slurry screening process, containing conventional pigmented red and blue phosphors but without the color filter layers. The brightness contrast performance for the screen assemblies prepared above exhibited enhancements of +8% to +11% compared to conventional tubes of the same type without color filter layers. The Contrast Ratio (CR) gain for the screen assemblies prepared above varied from +10% to +15% compared to conventional tubes of the same type without color filter layers. The tube face reflectance for the screen assemblies prepared above decreased between 15% to 22% compared to conventional tubes of the same type without color filter layers.

What is claimed is:

1. A method of manufacturing a luminescent screen assembly for a color cathode-ray tube (CRT), comprising:
providing a faceplate panel having a patterned light absorbing matrix thereon defining a first set of fields, a second set of fields and a third set of fields;
forming a blocking layer over the second set of fields and the third set of fields;
applying a first pigment layer to the first set of fields; and
removing the blocking layer in the second set of fields and the third set of fields.

2. The method of claim 1 wherein the first pigment layer is selected from t the group consisting of red pigment and blue pigment.

3. The method of claim 1 wherein the blocking layer comprises a photosensitive material.

4. The method of claim 3 wherein the blocking layer further comprises a filler material.

5. A method of manufacturing a luminescent screen assembly for a color cathode-ray tube (CRT), comprising:
providing a faceplate panel having a patterned light absorbing matrix thereon defining a first set of fields, a second set of fields and a third set of fields, wherein the first set of fields has a red pigment layer therein;
forming a blue pigment layer on the patterned light absorbing matrix over the second set of fields, the third set of fields and the red pigment layer in the first set of fields;
forming a blue phosphor layer on the blue pigment layer; and
removing the blue pigment layer in the third set of fields and over the red pigment layer in the first set of fields.

6. The method of claim 5 further comprising forming a green phosphor layer in the third set of fields.

7. The method of claim 6 further comprising forming a red phosphor layer over the red pigment layer in the first set of fields.

8. A method of manufacturing a luminescent screen assembly for a color cathode-ray tube (CRT), comprising:
providing a faceplate panel having a patterned light absorbing matrix thereon defining a first set of fields, a second set of fields and a third set of fields;
forming a blocking layer over the second set of fields and the third set of fields;
applying a blue pigment layer on the patterned light absorbing matrix over the first set of fields; and
removing the blocking layer in the second set of fields and the third set of fields.

9. The method of claim 8 wherein the blocking layer comprises a photosensitive material.

10. The method of claim 9 wherein the blocking layer further comprises a filler material.

11. The method of claim 8 further comprising forming a green phosphor layer in the second set of fields.

12. The method of claim 11 further comprising forming a blue phosphor layer over the blue pigment layer in the first set of fields.

13. The method of claim 12 further comprising forming a red phosphor layer in the third set of fields.
